(19) United States
(12) Patent Application Publication
(10) Pub. No.: US 2006/0054277 A1
(43) Pub. Date: Mar. 16, 2006

(54) Anisotropic-electroconductive adhesive, circuit connection method and structure using the same

(76) Inventors: Jung_Il Byun, Gyeonggi-do (KR); Kyung-Jun Lee, Gyeonggi-do (KR); Jae-Yong Jung, Gyeonggi-do (KR)

Correspondence Address: JONES DAY, 222 EAST 41ST ST, NEW YORK, NY, 10017, US

(21) Appl. No.: 10/538,801

(22) PCT Filed: Jul. 29, 2003
(86) PCT No.: PCT/KR03/01515

§ 371 Date: Jun. 13, 2005

(30) Foreign Application Priority Data
Dec. 13, 2002 (KR) 10-2002-0079857

(51) Int. Cl. B32B 7/12

(52) U.S. Cl. 156/327; 428/323; 524/556; 156/306.9

(57) ABSTRACT

Disclosed is an anisotropic-electroconductive adhesive, which includes an insulating adhesive component containing a radical polymerizable compound and a polymerization initiator; and a plurality of insulating coated electroconductive particles dispersed in the insulating adhesive component, the insulating coated electroconductive particle having a coating layer made of insulating thermoplastic resin on a surface of an electroconductive particle, wherein a softening point of the insulating thermoplastic resin is lower than an exothermic peak temperature of the insulating adhesive component. The anisotropic-electroconductive adhesive enables rapid curing of the insulating adhesive component at a low temperature and is very useful for making a circuit connection structure since it may prevent a short of circuit without connection failure even when the electroconductive particles are condensed.

### TECHNICAL FIELD

The present invention relates to an anisotropic-electroconductive adhesive, and a circuit connection method and structure using the adhesive. More particularly, the present invention relates to an anisotropic-electroconductive adhesive, which may be used in a structure requiring electrical connection of fine pattern circuits, such as a connection between LCD (Liquid Crystal Display) and a flexible circuit board or a TAB (Tape Automated Bonding) film, a connection between a TAB film and a printed circuit board, or a connection between a semiconductor IC and an IC-built circuit board, and circuit connection method and structure using the adhesive.

### BACKGROUND ART

Recently, electronic instruments become rapidly miniaturized with a smaller thickness along with the technical developments. This causes increase of connections between fine pattern circuits or between a fine pattern circuit and a minute part. An anisotropic-electroconductive adhesive is applied for those connections. A method for connecting fine pattern circuits using the conventional anisotropic-electroconductive adhesive is as follows.

Referring to FIG. 1, circuit electrodes 11 and 21 are provided on a lower surface of an upper board 10 and an upper surface of a lower board 20 respectively so that the circuit electrodes 11 and 21 are faced each other. An anisotropic-electroconductive adhesive 30 consisting of an insulating adhesive component 40 and a plurality of conductive particles 50 dispersed in the insulating adhesive component 40 is interposed between the circuit electrodes 11 and 21. After that, the upper and lower boards 10 and 20 are thermo-compressed at predetermined temperature and pressure. Then, the conductive particles 50 interposed between the circuit electrodes 11 and 21 makes the circuit electrodes 11 and 21 be electrically connected as shown in FIG. 2. In addition, the adjacent circuits may ensure insulation between them in the thermo-compression process. As the insulating adhesive component 40 is completely hardened, the upper plate 10 and the lower plate 20 are firmly adhered to each other. However, if the conductive particles 50 dispersed in the insulating adhesive component 40 are condensed as indicated by ‘A’ in FIG. 3, the conventional anisotropic-electroconductive adhesive may show electrical connection between the adjacent circuit electrodes, which may cause a short circuit.

The adhesive components used in the conventional anisotropic-electroconductive adhesive are generally classified into a thermoplastic type adhesive component and a thermosetting type, wherein the former has an adhesive property induced by heating and melting and the latter has that induced by heating and curing.

If the anisotropic-electroconductive adhesive using a thermoplastic resin as an adhesive component is used, it is required to control the heating temperature above a melting point of the resin when adhering. However, pursuant to the selection of the adhesive, it is possible to connect objects at a relatively low temperature, and it takes a short time to connect the objects because the connection using this adhesive does not come with a chemical reaction. As a result, the thermal damage of the connected objects can be inhibited. However, when connection of circuits using this adhesive is carried out, there can be caused problems regarding the reliability and stability of the connection because the thermal resistance, moisture resistance and chemical resistance of the connecting part have limits.

If the anisotropic-electroconductive adhesive using a thermosetting resin as an adhesive component is used, it is required to control the heating temperature the same as the curing temperature of the resin. Further, in order to obtain a sufficient adhesive strength and reliability of the connection, it is required to proceed the curing reaction sufficiently, and to maintain the heating temperature between 150° C. and 200° C. for about 30 seconds. Such a type of the anisotropic-electroconductive adhesive is principally used because it has an excellent heat resistance, moisture resistance and chemical resistance after a sufficient thermosetting.

Among the thermosetting resins, epoxy resin based adhesive has been mainly used. Because this adhesive can achieve a high adhesive strength, and excellent water resistance and thermal resistance, it is often used in a various applications, such as electricity, electronics, architectures, automobiles and aircraft. In particular, 1-packing type epoxy resin based adhesive is popularly used as a form of film, paste and powder in view of that it is not necessary to mix principal components and curing agent in the adhesive and that the adhesive can be simply used. However, although a film form of the epoxy resin based adhesive has a excellent working property, in the case that such a film type adhesive is used, it is required to heat the adhesive at 150° C.˜180° C. for about 20 seconds of connection time and at 180° C.˜210° C. for about 10 seconds of connection time.

Furthermore, because the current epoxy based adhesive is treated at a high temperature, the adhesive provides the connected objects with some problems such as thermal damage and size change occurred by thermal expansion and shrinking. Also, in the case using this adhesive, it is required to reduce the connection time to 10 seconds or less in order to enhance the productivity of the adhesive.

### DISCLOSURE OF INVENTION

The present invention is designed to solve such problems of the prior art, and therefore an object of the present invention is to provide a reliable anisotropic-electroconductive adhesive which ensures circuit connection in a short time, prevents a short circuit even when conductive particles are condensed, and has no connectional failure.

Another object of the present invention is to provide a circuit connection method using the anisotropic-electroconductive adhesive.

Still another object of the present invention is to provide a circuit connection structure using the anisotropic-electroconductive adhesive.

In one aspect of the present invention, there is provided an anisotropic-electroconductive adhesive, which includes an insulating adhesive component containing a radical polymerizable compound and a polymerization initiator; and a plurality of insulating coated electroconductive particles dispersed in the insulating adhesive component, the insulating coated electroconductive particle having a coating layer made of insulating thermoplastic resin on a surface of an electroconductive particle, wherein a softening point of the insulating thermoplastic resin is lower than an exothermic peak temperature of the insulating adhesive component.

Preferably, the exothermic peak temperature of the insulating adhesive component is in the range of 80° C.˜120° C. in the aspect of the rapid curing at a low temperature.

In addition, the coating layer made of the insulating thermoplastic resin preferably has a thickness of 0.01 μm˜10 μm in the view of the insulation of the coating layer and the electrical connection between the faced electrodes according to the softening of the coating layer.

In order to accomplish another object, the present invention also provides a circuit connection method, which includes comprising the steps of: (a) interposing an anisotropic-electroconductive adhesive including an insulating adhesive component containing a radical polymerizable compound and a polymerization initiator; and a plurality of insulating coated electroconductive particles dispersed in the insulating adhesive component, the insulating coated electroconductive particle having a coating layer made of insulating thermoplastic resin on a surface of an electroconductive particle, wherein a softening point of the insulating thermoplastic resin is lower than an exothermic peak temperature of the insulating adhesive component, between circuit boards respectively having circuit electrodes faced each other; (b) electrically connecting the faced circuit electrodes by removing a part of the insulating thermoplastic resin coating layer on the surface of the electroconductive particle contacted with the faced circuit electrodes by means of thermal pressing; and (c) curing the insulating adhesive component so that the circuit electrodes are adhered and fixed.

In order to fulfill still another object, there is also provided a circuit connection structure in which the anisotropic-electroconductive adhesive, which includes an insulating adhesive component containing a radical polymerizable compound and a polymerization initiator; and a plurality of insulating coated electroconductive particles dispersed in the insulating adhesive component, the insulating coated electroconductive particle having a coating layer made of insulating thermoplastic resin on a surface of an electroconductive particle, wherein a softening point of the insulating thermoplastic resin is lower than an exothermic peak temperature of the insulating adhesive component, is interposed between circuit boards respectively having circuit electrodes faced each other so that the circuit electrodes are electrically connected each other.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a schematic view showing a conventional anisotropic-electroconductive adhesive interposed between circuit boards having circuit electrodes facing each other;

FIG. 2 is a schematic view showing a circuit connection structure electrically connected using the conventional anisotropic-electroconductive adhesive;

FIG. 3 is a schematic view for illustrating a short circuit of the circuit connection structure electrically connected using the conventional anisotropic-electroconductive adhesive;

FIG. 4 is a sectional view showing an anisotropic-electroconductive adhesive according to an embodiment of the present invention;

FIG. 5 is a sectional view showing an insulating coated conductive particle dispersed in the anisotropic-electroconductive adhesive of the present invention;

FIG. 6 is a schematic view showing an anisotropic-electroconductive adhesive interposed between circuit boards having circuit electrodes facing each other according to the present invention; and

FIG. 7 is a schematic view showing a circuit connection structure electrically connected using the anisotropic-electroconductive adhesive of the present invention.

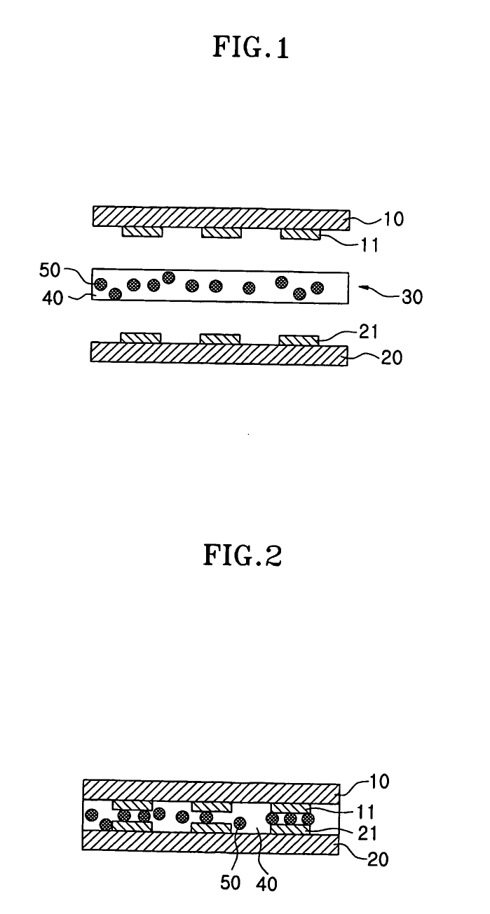

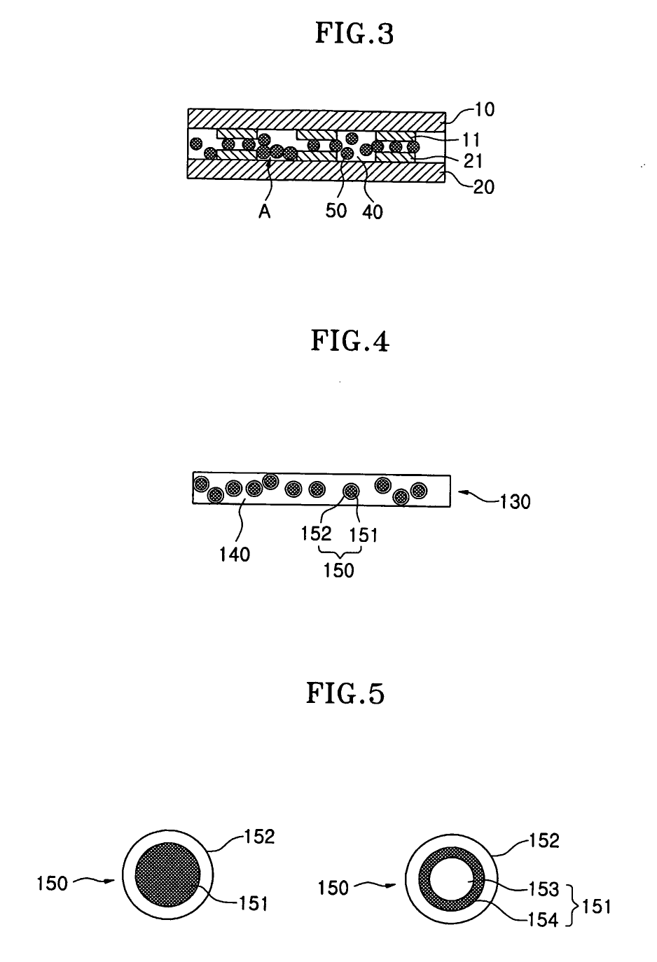

### BEST MODES FOR CARRYING OUT THE INVENTION

Hereinafter, an anisotropic-electroconductive adhesive, a circuit connection method using the same, and a circuit connection structure according to the present invention will be described in detail.

In the anisotropic-electroconductive adhesive according to the invention, an adhesive component is used to give secure adhesion between the substrates. The component contains radical polymerizable compounds and a polymerization initiator. It is preferable that exothermic peak temperature of the component is between 80° C. and 120° C. in view of quick curing at a low temperature and storage properties.

The radical polymerizable compounds are the materials having a functional group which is polymerized by means of a radical. In addition to monomer, as the compounds, oligomers can be used alone or in combination with monomer. The radical polymerizable compounds include, for example, acrylate based or methacrylate based compounds, such as, methyl acrylate, ethyl acrylate, bisphenol-A ethylene glycol modified diacrylate, ethylene glycol isocyanurate modified diacrylate, tripropylene glycol diacrylate, tetraethylene glycol diacrylate, polyethylene glycol diacrylate, pentaerythritol triacrylate, trimethylol propane triacrylate, trimethylol propane propylene glycol triacrylate, trimethylol propane ethylene glycol triacrylate, ethylene glycol isocyanurate modified triacrylate, dipentaerythritol pentaacrylate, dipentaerythritol hexaacrylate, pentaerythritol tetraacrylate, dicyclopentenyl acrylate, tricyclodecanyl acrylate. In particular, acrylate based or methacrylate based compounds having dicyclopentenyl group and/or tricyclodecanyl groups and/or triazine ring may be preferably used because they have high thermal resistance. In addition, the radical polymerizable compounds are maleimide compound, unsaturated polyester, acrylic acid, vinyl acetate, acrylonitrile, methacrylonitrile and so forth, which can be used alone or in combination therewith.

The polymerization initiators carry out the function that activates any radical polymerizable compound to form a high molecular network structure or a high molecular IPN structure. As such a cross-linked structure is formed, the insulating adhesive component is cured. As the polymerization initiators, thermal polymerization initiators and/or photo-polymerization initiators may be used. Although the content of the initiators may be varied pursuant to the kinds of radical polymerizable compounds and the reliability and work property of the desired adhesion procedure of circuit, 0.1˜10 wt % of the initiator per 100 wt % of the radical polymerizable compounds is preferable.

The thermal polymerization initiators are the compounds which are decomposed by heating and produce free radical. The initiators are peroxide compounds, azo-based compounds, and so forth, and in particular organic peroxides are preferably used. The organic peroxides have O—O— bind therein, and produce a free radical by heating and then represent an activity. The organic peroxides are classified into ketone peroxides, peroxyketals, hydroperoxides, dialkyl peroxides, diacyl peroxides, peroxycarbonates, peroxyesters and so forth. The ketone peroxides include cyclohexanone peroxide, methylcyclohexanone peroxide and so forth; the peroxyketals include 1,1-bis(t-butylperoxycyclohexanone), 1,1-bis(t-butylperoxy-3,3,5-trimethylcyclohexanone) and so forth; the hydroperoxides include t-butyl hydroperoxide, cumene hydroperoxide and so forth; the dialkyl peroxides include dicumyl peroxide, di-t-butylperoxide and so forth; the diacyl peroxides include lauroyl peroxide, benzoyl peroxide and so forth; the peroxydicarbonates include diisopropyl peroxydicarbonate, bis-(4-t-butyl cyclohexyl)peroxy dicarbonate and so forth; and the peroxyesters include t-butyl peroxybenzoate, t-butyl peroxy(2-ethyl hexanoate), t-butyl peroxyisopropyl carbonate, 1,1,3,3-tetramethyl butyl peroxy-2-ethyl hexanoate and so forth. In view of the balance of the properties concerning storage, cure and adhesion, peroxyketals and peroxyesters are preferably used. In addition, inorganic peroxide type thermal polymerization initiators include potassium persulfate and amonium persulfate and so forth; azo-based thermal polymerization initiators include azobis isobutyronitrile, 2,2′-azobis-2-methyl butyronitrile and 4,4-azobis-4-cyanovaleric acid. The aforesaid thermal polymerization initiators are used alone or in combination therewith. It is possible to cure radical polymerizable compounds within a short time by selecting suitable thermal polymerization initiator(s) on the consideration of desirable connection temperature, connection time, available time and so forth.

Furthermore, instead of the thermal polymerization initiators, photo-polymerization initiators can be used. The photo-polymerization initiators may be used in combination pursuant to the radical polymerizable compounds, and include carbonyl compounds, sulfur compounds, azo-based compounds, and so forth.

In the anisotropic-electroconductive adhesive according to the invention, the insulating adhesive components can be used together with epoxy resin, epoxy based curing agent, phenol resin and phenol based curing agent as well as radical polymerizable material and polymerization initiator, in view of the enhancement of adhesive ability and reliability. It is preferable that 20˜200 wt % of the insulating adhesive components is added on the basis of 100 wt % of radical polymerizable compound.

Furthermore, in the anisotropic-electroconductive adhesive according to the invention, insulating adhesive components preferably contain thermoplastic resin. Although the resin used in the current epoxy based adhesive can be used as the thermoplastic resin, in particular, it is preferable to use the resin compatible with the radical polymerizable compounds for quick curing. Such thermoplastic resins are styrene-butadiene copolymer, styrene-isoprene copolymer, styrene-butadiene saturated copolymer, styrene-isoprene saturated copolymer, styrene-ethylene-butene-styrene copolymer, acrylonitrile-butadiene copolymer, methyl methacrylate polymer, acrylic rubber, urethane resin, penoxy resin, polyester resin, polystyrene resin, polyvinyl butylal resin, polyvinyl formal, polyamide, polyimide, thermoplastic epoxy resin and phenol resin, and so forth. In view of the enhancement of adhesive ability, it is preferable to use urethane resin or phenoxy resin. The anisotropic-electroconductive adhesive can be produced in the form of film using the aforesaid thermoplastic resins. In this case, if having hydroxyl group or carboxylic group at the end thereof, the thermoplastic resins preferably give an improved adhesive ability. These thermoplastic resins can be used alone or in combination. The ratio of the amount of the thermoplastic resins compounded to that of the radical polymerizable compounds is preferably from 10/90 to 90/10, more preferably from 30/70 to 70/30.

Furthermore, if necessary, filler, softening agent, promoter, coloring agent, flame-resistant agent, photo-stabilizer, coupling agent, polymerization inhibitor and so forth may be added to the anisotropic-electroconductive adhesive according to the invention. For example, when the filler is added, the connection reliability is improved. In addition, when the coupling agent is added, the adhesive ability of the adhering surface of the anisotropic-electroconductive adhesives is improved, and the adhesive strength, thermal resistance or moisture resistance can be improved to increase the connection reliability. Such a coupling agent is in particular, silane coupling agent, for example, β-(3,4-epoxycyclohexyl)ethyl trimethoxy silane, γ-mercaptopropyl trimethoxy silane, γ-methacryloxy propyltrimethoxy silane and so forth.

The insulating coated electroconductive particle constituting the anisotropic-electroconductive adhesives according to the invention is prepared by the following procedures.

All of the electroconductive particles coated with insulating thermoplastic resin can be used if they can ensure electrical connection between circuits. For example, as shown in FIGS. 5 (a) and (b), as the electroconductive particles, metal such as nickel, iron, copper, aluminum, tin, zinc, chrome, cobalt, silver, gold, etc. or the particle itself having electroconductive property for example metal oxide, solder, carbon, etc. can be used. Otherwise, the particle forming a metal thin layer 154 onto the surface of the nucleus materials 153 such as glass, ceramic, polymer, etc., by means of layer-forming method such as electroless plating can be used as the electroconductive particle 151. In particular, the electroconductive particle in which a metal thin layer is formed on the surface of each polymeric nucleus material is transformed in the direction of pressure under the pressing procedure to increase the contact area with electrode so that the reliability of electrical connection is improved. The polymeric nucleus materials may be prepared with various acrylates such as polyethylene, polypropylene, polystyrene, methyl methacrylate-styrene copolymer, acrylonitrile-styrene copolymer, acrylonitrile-butadiene-styrene copolymer, polycarbonate and polymethyl methacrylate; polyvinyl butyral, polyvinyl formal, polyimide, polyamide, polyester, polyvinyl chloride; various polymeric resins such as fluorine resin, urea resin, melamine resin, benzoguanamine resin, phenol-formalin resin, phenol resin, xylene resin, diaryl phthalate resin, epoxy resin, polyisocyanate resin, phenoxy resin, silicone resin. These resins may be used alone or in combination of at least two resins. Moreover, if necessary, it is possible to use polymeric resins having a cross-linked structure produced by adding additives such as cross-linking agent and curing agent, and then by reacting them. The nucleus materials can be produced by the methods such as emulsion polymerization, suspension polymerization, non-aqueous dispersion polymerization, dispersion polymerization, interface polymerization, in-situ polymerization, curing-in-solution coating, drying-in-solution, melting-dispersion cooling, spray drying, etc. The electroconductive particles preferably have a smaller particular diameter than the distance of the circuit electrodes. The particular diameter is preferably 0.1˜50 μm, more preferably 1˜20 μm, most preferably 2˜10 μm.

The materials of the coating layer formed on the surface of the electroconductive particle have both insulating and thermoplastic properties. All the resins can be used if they have a softening point lower than the exothermic peak temperature of insulating adhesive component in which the insulating coated electroconductive particles are dispersed. The insulating thermoplastic resins include polyethylene and the copolymer thereof, polystyrene and the copolymer thereof, polymethyl methacrylate and the copolymer thereof, polyvinyl chloride and the copolymer thereof, polycarbonate and the copolymer thereof, polypropylene and the copolymer thereof, ester acrylate based rubber, polyvinyl acetal, polyvinyl butyral, acrylonitrile-butadiene copolymer, phenoxy resin, thermoplastic epoxy resin, polyurethane, and so forth. These resins can be used alone or in combination of at least two resins, or modified suitably.

The known coating method, such as electrostatic painting, thermal-melting coating, solution application and dry-blend method, can be used as the method for forming the coating layer containing the insulating thermoplastic resins onto the surface of the electroconductive particle. For example, the method for coating the insulating thermoplastic resins onto the electroconductive particle, in which a metal thin layer is formed onto the surface of the resin particle by means of the solution application, is described as follows. First, in order to easily bind the resin particle on which the metal thin layer is formed with the insulating thermoplastic resin coated thereon, the surface of the particle is treated using coupling agent, such as silane coupling agent or titanium based coupling agent. For example, if the electroconductive particles in which the metal thin layer is formed on the surface of the resin particle are evenly dispersed into the silane coupling agent solution, and stirred for about one hour and then dried, the electroconductive particles of which surface was treated with silane coupling agent are obtained. Subsequently, the electroconductive particles of which surface was treated are dissolved and evenly dispersed into the insulating thermoplastic resin solution which is scheduled to be coated on the surface-treated electroconductive particle. Then, after the insulating thermoplastic resin solution is dropped while evenly dispersing with a homogenizer and then was freeze dried, the insulating coated electroconductive particle coated with insulating thermoplastic resin is obtained.

The thickness of the insulating thermoplastic resin coating layer is preferably 0.01˜10 μm, more preferably 0.05˜5 μm, most preferably 0.2˜2 μm, and the ratio of the thickness to the particular diameter of the insulating particle is preferably 1/100˜1/5, more preferably 1/50˜1/10 compared. If the thickness of the insulating thermoplastic resin coating layer is too thin, the insulating ability is lowered, while, if too thick, the insulating coating layer in the direction of the pressure contacted with the circuit electrode may not be removed even during the heat-pressing, which may cause continuity failure.

The content of the insulating coated electroconductive particles is preferably 0.1˜30 wt % to 100 wt % of the insulating adhesive component. Owing to the insulating coating layer formed on the surface of the electroconductive particle, there is not caused any electrical connection between the electroconductive particles, thereby a short circuit, even though the electroconductive particles are condensed. In this reason, the ratio of the insulating coated electroconductive particles may be increased up to about ⅓ by weight of the insulating adhesive component.

Hereinafter, the operation by which circuits are connected using the anisotropic-electroconductive adhesive according to the present invention is described as follows.

Referring to FIG. 4, a plurality of insulating coated electroconductive particles 150 wherein a coating layer 152 made of insulating thermoplastic resin is formed on the surface of an electroconductive particle 151 are dispersed in an insulating adhesive component 140. The insulating thermoplastic resin forming the coating layer 152 formed on the surface of the electroconductive particle 151 has a softening point lower than exothermic peak temperature of the insulating adhesive component 140. Here, the exothermic peak temperature means a maximum exothermic temperature which is measured whiling increasing the temperature of the adhesive component from the vicinities at the ratio of 10° C./min by use of a DSC (Differential Scanning Calorimetry). In other words, at the exothermic peak temperature, the reaction is most abrupt. The circuits are then connected using the anisotropic-electroconductive adhesive 130 as follows.

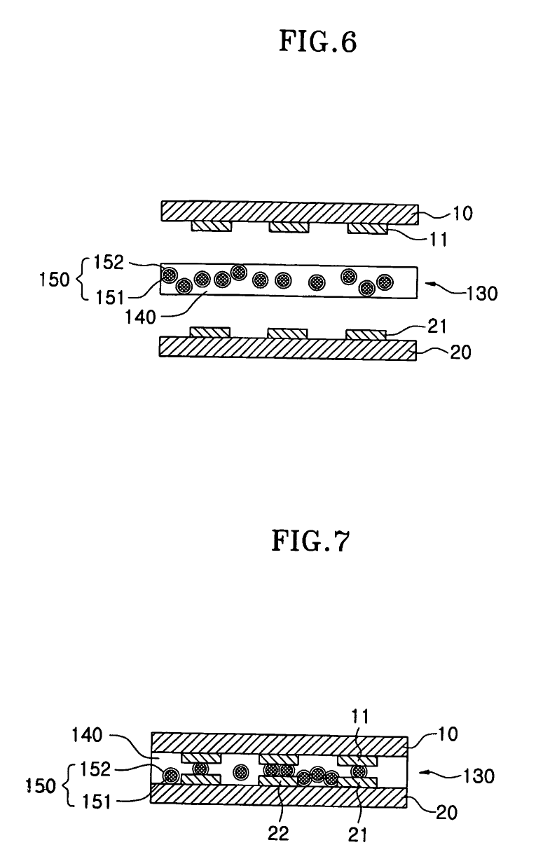

First, the above-mentioned anisotropic-electroconductive adhesive 130 is interposed between an upper plate 10 and a lower plate 20, which respectively have circuit electrodes 11 and 21, faced each other (see FIG. 6).

Subsequently, if thermally pressed at predetermined temperature and pressure, the insulating thermoplastic resin in the coating layer 152 is softened before the insulating adhesive component 140 is cured. Thus, a part of the coating layer 152 which is contacted with the circuit electrodes 11 and 21 in a pressure direction is removed, and then the circuit electrodes 11 and 21 become electrically connected through the electroconductive particles 151. On the other hand, though softened, a part of the coating layer 152 which is not in the pressure direction is not deviated from the surface of the electroconductive particle 151. Thus, the insulation between the adjacent electrodes is kept even though the insulating coated electroconductive particles 150 are condensed. This may prevent a short circuit. If the softening point of the insulating thermoplastic resin composing the coating layer 152 formed on the electroconductive particle 151 is higher than the exothermic peak temperature of the insulating adhesive component 140, the insulating adhesive component 140 will be cured before the coating 152 is softened, so the coating layer which is contacted with the circuit electrodes 11 and 21 in the pressure direction are not removed, thereby causing a short circuit.

After that, the insulating adhesive component 140 is completely cured so that the upper plate 10 and the lower plate 20 are firmly adhered and fixed. Through the above procedure, there may be provided a circuit connection structure having high reliability in which two facing circuit electrodes are electrically connected using the anisotropic-electroconductive adhesive according to the present invention.

Hereinafter, embodiments of the present invention will be described in detail. However, the embodiments of the present invention may be modified in various ways, and it should be not interpreted that the scope of the invention is limited to those embodiments. The embodiments of the present invention are provided just for the purpose of giving better explanation of the invention to those having ordinary knowledge in the art.

### FIRST EMBODIMENT

Preparation of Insulating Coated Electroconductive Particles

Electroconductive particles made of metal-coated resin particles (manufactured by Sekisui Chemical, Micropearl AU205™, 5.0 μm) are put into 5 wt % of acetone solution, namely 3-Methacryloxypropyl trimethoxy Silane (manufactured by Aldrich), and uniformly dispersed therein and then dried to obtain surface-treated electroconductive particles. Subsequently, 3 g of the surface-treated electroconductive particles are added into a solution in which 3 g of polystryene (manufactured by Nova Chemical, STYROSUN 2158™, a softening point is 96° C.) is dissolved in 15 g of n-hexane. After that, the solution is slowly added into 100 g of solution containing nonionic emulsifier (Sorbitan monolaurate) while being mixed uniformly by a homogenizer and then freeze-dried to obtain an insulating coated electroconductive particle which is an electroconductive particle coated with polystryene. Here, a thickness of the coating layer is 0.7 μm.

Preparation of Anisotropic-Electroconductive Adhesive

50 g of phenoxy resin (Inchem Co., PKHC™, an average molecular weight is 45,000) is dissolved into a mixed solution in which toluene (a boiling point is 110.6° C. and an SP value is 8.90) and acetone (a boiling point is 56.1° C. and an SP value is 10.0) are mixed in the weight ratio of 50:50, to prepare a solution containing 40% of solids. Subsequently, the solution is compounded to have, in the aspect of solid weight ratio, 50 g of phenoxy resin, 50 g of trihydroxyethylglycoldimethacrylate resin (manufactured by Kyoeisha Chemical, 80 MFA™) as a radical polymerizable compound, and 3 g of t-butylperoxy-2-ethylhexanonate (manufactured by SEKI ATOFINA, Ruperox 26™) as a polymerization initiator, thereby manufacturing insulating adhesive component. Then, 3 wt % of the insulating coated electroconductive particles prepared as above is mixed into 100 wt % of this adhesive component and dispersed evenly to make the anisotropic-electroconductive adhesive. After that, the anisotropic-electroconductive adhesive is coated on a PET film having a thickness of 50 μm, in which one side is surface-treated, by use of an applicator, and then dried by hot wind at 70° C. for 10 minutes to obtain the anisotropic-electroconductive adhesive film in which the adhesive layer has a thickness of 35 μm. Here, the exothermic peak temperature of the insulating adhesive component is measured to be 107° C.

### SECOND EMBODIMENT

50 g of phenoxy resin (Inchem Co., PKHC™, an average molecular weight is 45,000) is dissolved into a mixed solution in which toluene (a boiling point is 110.6° C. and an SP value is 8.90) and acetone (a boiling point is 56.1° C. and an SP value is 10.0) are mixed in the weight ratio of 50:50, to prepare a solution containing 40% of solids. Subsequently, the solution is compounded to have, in the aspect of solid weight ratio, 50 g of phenoxy resin, 30 g of trihydroxyethylglycoldimethacrylate resin (manufactured by Kongyoungsa Fat&Oil, 80 MFA™), 1.8 g of t-butylperoxy-2-ethylhexanonate (manufactured by Segiatopina, Ruperox 26™), 20 g of thermosetting phenol resin (manufactured by Kolon Chemical, KRD-HM2™), and 1 g of curing agent (Hexamethylene tetramine, HMTA), thereby manufacturing insulating adhesive component. Then, 3 wt % of the insulating coated electroconductive particles of the first embodiment is mixed into 100 wt % of this adhesive component and dispersed evenly to make the anisotropic-electroconductive adhesive. After that, the anisotropic-electroconductive adhesive is coated on a PET film, in which one side having a thickness of 50 μm is hetero-treated, by use of an applicator, and then dried by hot wind at 70° C. for 10 minutes to obtain the anisotropic-electroconductive adhesive film in which the adhesive layer has a thickness of 35 μm. Here, the exothermic peak temperature of the insulating adhesive component is measured to be 109° C.

### COMPARATIVE EXAMPLE 1

The anisotropic-electroconductive adhesive film is manufactured in the same method as the first embodiment, except that polystryene (manufactured by Nova Chemical, DYLARK 232™) having a softening point of 122° C. instead of polystryene (manufactured by Nova Chemical, STYROSUN 2158™) of the first embodiment having a softening point of 96° C.

The anisotropic-electroconductive adhesive films manufactured by the first and second embodiments and the comparative example 1 are respectively interposed between Flexible Printed Circuit (FPC) including 500 copper circuits having 50 μm of line width, 100 μm of pitch and 18 μm of thickness. An adhesive surface of the anisotropic-electroconductive adhesive film is attached to one side of the FPC and then thermally pressed for 5 seconds at 70° C., 5 kg/cm² for provisional connection through 2 mm of width. After that, the PET film is separated so that the anisotropic-electroconductive adhesive film is connected to the other side of the FPC, thereby connecting the circuit. Subsequently, the film is thermally pressed for 10 seconds at 160° C., 30 kg/cm² to make the circuit connection structure.

For the circuit connection structure manufactured as above, adhesive strength, correction resistance, and reliability of connection resistance after 1000 hours under the condition of 65° C. and relative humidity 95% are measured. The results of measurement are shown in the following Table 1.

TABLE 1

| | | | Reliability of |
|---|---|---|---|
| | Adhesive Strength | Connection | Connection |
| | (g/cm) | Resistance (Ω) | Resistance (Ω) |
| First Embodiment | 815 | 1.0 | 4.0 |
| Second | 950 | 1.1 | 4.3 |
| Embodiment | | | |
| Comparative | 812 | 24.0 | N/A |
| Example 1 | | | |

Seeing Table 1, it would be understood that the circuit connection structures using the anisotropic-electroconductive adhesive according to the first and second embodiment of the present invention show good adhesive strength, connection resistance and reliability of connection resistance.

On the other hand, it is estimated that the comparative example 1 shows high connection resistance since the polystyrene resin composing the insulating coating layer of the electroconductive particle has the softening point of 122° C. higher than the exothermal peak temperature of 107° C. of the insulating adhesive component, and therefore the adhesive component is cured before the insulating coating layer of the insulating coated electroconductive particle is softened and sufficiently removed.

### INDUSTRIAL APPLICABILITY

As described above, the anisotropic-electroconductive adhesive of the present invention may dramatically increase production efficiency since the rapid curing at a low temperature is possible. In addition, the anisotropic-electroconductive adhesive of the present invention is very useful for making a circuit connection structure since it may prevent a short of circuit without connection failure even when the electroconductive particles are condensed.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. An anisotropic-electroconductive adhesive comprising:
an insulating adhesive component containing a radical polymerizable compound and a polymerization initiator; and
a plurality of insulating coated electroconductive particles dispersed in the insulating adhesive component, the insulating coated electroconductive particle having a coating layer made of insulating thermoplastic resin on a surface of an electroconductive particle,
wherein a softening point of the insulating thermoplastic resin is lower than an exothermic peak temperature of the insulating adhesive component.

2. An anisotropic-electroconductive adhesive according to claim 1,
wherein the exothermic peak temperature of the insulating adhesive component is in the range of 80° C.˜120° C.

3. An anisotropic-electroconductive adhesive according to claim 1,
wherein the coating layer made of the insulating thermoplastic resin has a thickness of 0.0 μm˜10 μm.

4. An anisotropic-electroconductive adhesive according to claim 1 or 3,
wherein the electroconductive particle is made by forming a metal thin layer onto a surface of a nucleus material.

5. An anisotropic-electroconductive adhesive according to claim 1 or 2,
wherein the insulating adhesive component further includes thermosetting resin and a curing agent.

6. An anisotropic-electroconductive adhesive according to claim 1,
wherein the radical polymerizable compound is acrylate based or metacrylate based compound.

7. An anisotropic-electroconductive adhesive according to claim 1 or 2,
wherein the polymerization initiator is organic peroxide.

8. An anisotropic-electroconductive adhesive according to claim 1 or 2,
wherein the insulating adhesive component further includes thermoplastic resin.

9. A circuit connection method comprising the steps of:
(a) interposing an anisotropic-electroconductive adhesive including an insulating adhesive component containing a radical polymerizable compound and a polymerization initiator; and a plurality of insulating coated electroconductive particles dispersed in the insulating adhesive component, the insulating coated electroconductive particle having a coating layer made of insulating thermoplastic resin on a surface of an electroconductive particle, wherein a softening point of the insulating thermoplastic resin is lower than an exothermic peak temperature of the insulating adhesive component, between circuit boards respectively having circuit electrodes faced each other;
(b) electrically connecting the faced circuit electrodes by removing a part of the insulating thermoplastic resin coating layer on the surface of the electroconductive particle contacted with the faced circuit electrodes by means of thermal pressing; and
(c) curing the insulating adhesive component so that the circuit electrodes are adhered and fixed.

10. A circuit connection structure in which the anisotropic-electroconductive adhesive defined in the claim 1 is interposed between circuit boards respectively having circuit electrodes faced each other so that the circuit electrodes are electrically connected each other.
